(19) United States
(12) Patent Application Publication
(10) Pub. No.: US 2023/0402210 A1
(43) Pub. Date: Dec. 14, 2023

(54) MAGNETIC SHEET AND INDUCTOR

(71) Applicant: NITTO DENKO CORPORATION, Osaka (JP)

(72) Inventors: Hiroki SENDA, Osaka (JP); Keisuke OKUMURA, Osaka (JP); Yoshihiro FURUKAWA, Osaka (JP)

(73) Assignee: NITTO DENKO CORPORATION, Osaka (JP)

(21) Appl. No.: 18/252,145

(22) PCT Filed: Nov. 11, 2021
(86) PCT No.: PCT/JP2021/041544

§ 371 Date: May 8, 2023

(30) Foreign Application Priority Data
Nov. 12, 2020 (JP) 2020-188974

(51) Int. Cl. H01F 1/26; H01F 17/04

(52) U.S. Cl. CPC H01F 1/26; H01F 17/04

(57) ABSTRACT

A magnetic sheet has a first principal surface and a second principal surface facing each other in the thickness direction. The magnetic sheet contains magnetic particles and resin. The ratio of the total amount of carbon and oxygen on one of the first principal surface and second principal surface is 10 mass % or more and 60 mass % or less.

### TECHNICAL FIELD

The present invention relates to a magnetic sheet and an inductor.

### BACKGROUND ART

Magnetic sheets containing magnetic particles and resin have been known (for example, see Patent Document 1 cited below). In Patent Document 1, the magnetic particles and resin are dispersed in an organic solvent, thereby preparing a magnetic composition solution (varnish). The magnetic composition solution is applied on a separator, dried, and thereafter heated. In this manner, the magnetic sheet is produced. The magnetic sheets are laminated and adhered to each other, and the laminate is adhere to a substrate, or covers a wire to adhere to the wire.

### CITATION LIST

### Patent Document

Patent Document 1: Japanese Unexamined Patent Publication No. 2017-5114

### SUMMARY OF THE INVENTION

### Problem to be Solved by the Invention

In the method of Patent Document 1. however, the particles go down during the drying, Thus, the ratio of the resin on the front surface may excessively increase. This increases the adhesion on the front surface of the magnetic sheet.

When the ratio of the resin excessively decreases on the rear surface, it reduces the adhesion on the rear surface. However, there is a need to achieve (balance well) both of excellent adhesiveness on the front surface and excellent adhesiveness on the rear surface of the magnetic sheet.

The present invention provides a magnetic sheet and an inductor that achieve both of excellent adhesiveness on the first principal surface and excellent adhesiveness on the second principal surface.

### Means for Solving the Problem

The present invention [1] includes a magnetic sheet comprising: a first principal surface; and a second principal surface, the first principal surface and second principal surface facing each other in a thickness direction, the magnetic sheet containing magnetic particles and resin, wherein a ratio of a total amount of carbon and oxygen on the first principal surface or second principal surface is 10 mass % or more and 60 mass % or less.

The present invention [2] includes the magnetic sheet described in [1] above, wherein the ratio of the total amount on each of the first principal surface and second principal surface is 10 mass % or more and 50 mass % or less.

The present invention [3] includes the magnetic sheet described in [1] or [2] above, wherein the ratio of the total amount on the first principal surface equals the ratio of the total amount on the second principal surface, or the ratio of the total amount on one surface of the first principal surface and second principal surface is lower than the ratio of the total amount on the other surface, and the ratio of the total amount on the one surface to the ratio of the total amount on the other surface is 0.3 or more and less than 1.0.

The present invention [4] includes the magnetic sheet described in any one of [1] to [3], wherein the ratio of the total amount on one surface of the first principal surface and second principal surface equals the ratio of the total amount at a central part in the thickness direction, or the ratio of the total amount on the one surface is lower than the ratio of the total amount at the central part, and the ratio of the total amount on the one surface to the ratio of the total amount at the central part is 0.3 or more and less than 1.0.

The present invention [5] includes an inductor comprising: a wire; and a magnetic sheet described in any one of [1] to [4] and covering the wire.

### Effects of the Invention

In the magnetic sheet of the present invention, the ratio of the total amount of carbon and oxygen is 10 mass % or more and 60 mass % or less on the first principal surface or second principal surface. Thus, excessive decrease in the ratio of the resin can he suppressed on the first principal surface and second principal surface.

Thus, the magnetic sheet and inductor can achieve both of excellent adhesiveness on the first principal surface and excellent adhesiveness on the second principal surface.

### BRIEF DESCRIPTION OF THE DRAWINGS

FIG. 1 is a cross-sectional view of an embodiment of the magnetic sheet of the present invention.

FIG. FIG. 2A and FIG. 2B illustrate the steps of producing the magnetic sheet by a first production method. FIG. 2A illustrates a step of preparing a coating film. FIG. 2B illustrates a step of drying the coating film with a first dryer.

FIG. 3 is a schematic view of drying the coating film with a second dryer in a second production method.

FIG. 4A and FIG. 4B illustrate the steps of producing a laminate magnetic sheet. FIG. 4A illustrates a step of disposing a plurality of magnetic sheets, FIG. 413 illustrates a step of producing the laminate magnetic sheet.

FIG. 5 is a cross-sectional view of an inductor.

FIG. 6A and FIG. 6B are a side view of the measurement of the adhesion of Example. FIG. 6A illustrates a test A. FIG. 6B illustrates a test B.

### DESCRIPTION OF THE EMBODIMENTS

### <Embodiment of Magnetic Sheet>

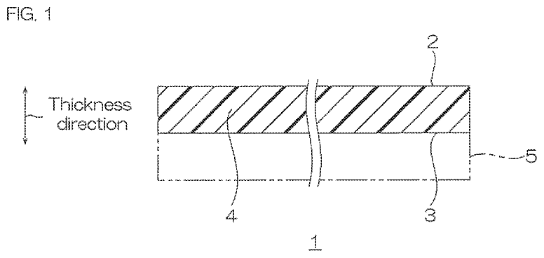

An embodiment of the magnetic sheet of the present invention is described with reference to FIG. 1.

As illustrated in FIG. 1, a magnetic sheet 1 has a first principal surface 2 and a second principal surface 3. The first principal surface 2 and second principal surface 3 face each other in a thickness direction. The magnetic sheet 1 extends in a direction orthogonal to the thickness direction. The magnetic sheet 1 contains magnetic particles and resin. The magnetic particles and resin are described in detail below.

<Ratio of Total Amount of Carbon And Oxygen on First Principal Surface And Second Principal Surface>The first principal surface 2 or second principal surface 3 has a ratio of the total amount of carbon and oxygen of 10 mass % or more and 60 mass % or less. When the ratio of the total amount of carbon and oxygen on the first principal surface 2 or second principal surface 3 is less than the above-described lower limit (10 mass %), the ratio of resin becomes excessively low on the first principal surface 2 and second principal surface 3. When the ratio of the total amount of carbon and oxygen on the first principal surface 2 or second principal surface 3 is more than the above-described upper limit (60 mass %), the ratio of resin becomes excessively high on the first principal surface 2 and second principal surface 3. In both of the cases, excellent adhesion cannot be achieved on both of the first principal surface 2 and second principal surface 3. The ratio of the total amount of carbon and oxygen on the first principal surface 2 or second principal surface 3 is, preferably, 13 mass % or more, more preferably, 15 mass % or more, even more preferably, 17 mass % or more, The ratio of the total amount of carbon and oxygen on the first principal surface 2 or second principal surface 3 is, preferably, 50 mass % or less, more preferably, 40 mass % or less, even more preferably, 25 mass % or less. When the ratio of the total amount of carbon and oxygen on the first principal surface 2 or second principal surface 3 is the above-described lower limit or more, or, the above-described upper limit or less, excellent adhesion can more surely be achieved on both of the first principal surface 2 and second principal surface 3.

Further, the ratio of the total amount of carbon and oxygen on each of the first principal surface 2 and second principal surface 3 is, for example, 10 mass % or more, preferably, 15 mass % or more and, for example, 50 mass % or less. In such a case, on both of the first principal surface 2 and second principal surface 3, excessive segregation of particles is suppressed, the ratio of the resin is appropriate, and the adhesion can be balanced on the first principal surface 2 and the second principal surface 3.

The ratio of the total amount of carbon and oxygen on each of the first principal surface 2 and second principal surface 3 can be obtained by Energy-dispersive X-ray spectroscopy (EDX). The ratio of the total amount of carbon and oxygen means the relative ratio of the carbon and oxygen to all the elements constituting the magnetic sheet 1 and is an index of the ratio of the organic component, namely, resin (organic component) in the magnetic sheet 1. As a method of analyzing the elements constituting the magnetic sheet 1, an EDX analysis may be used as follows.

For example, when the magnetic sheet 1 contains Fe—Si magnetic particles (described below) and resin, the constituent elements of the magnetic sheet 1 are C, O, Si, and Fe. In this case, the ratio of the total amount of carbon and oxygen means the relative ratio of the total amount of C and O to the total of C, O, Si, and Fe. In other words, the ratio of the total amount of carbon and oxygen indicates the ratio (percentage) of C and O when the total of C, O, Si, and Fe is 100%. EDX analysis may use an element, such as Pt, in a pretreatment for preparing the sample. However, such an element is removed.

The analysis field of the FDX analysis is, for example, in a range of a width between 300 and 2, 500 μm and a height between 200 and 2, 500 μm, more preferably in a range of a width between 500 and 700 μm and a height between 300 and 500 μm. The analysis may be carried out at an analysis point of a field or a plurality of analysis points of a plurality of fields. To grasp the tendency of the whole of the principal surface, the analysis is preferably carried out at a plurality of analysis points for example, at two to four analysis points). Specifically, the average value of the analysis points is obtained.

The magnification in the EDX analysis is, for example, 50 times or more, preferably 100 times or more, and, for example, 400 times or less, preferably 300 times or less in view of grasping the tendency of the whole of the principal surface.

At the EDX analysis of each of the first principal surface 2 and the second principal surface 3, the surfaces of the first principal surface 2 and second principal surface 3 are simultaneously observed by SEM.

The ratio of the total amount of carbon and oxygen on the first principal surface 2 preferably equals the ratio of the total amount of carbon and oxygen on the second principal surface 3 (a requirement [1]).

In the present application, the verb “equal” as to the ratios on the first principal surface 2 and second principal surface 3 includes a relationship where the product of one of the ratios multiplied by a numerical value of 0.95 or more and 1.04 or less equals the other (in other words, a relationship where one approximately equals the other).

When the ratio of the total amount of carbon and oxygen on one surface of the first principal surface 2 and second principal surface 3 is less than the ratio of the total amount of carbon and oxygen on the other surface, a ratio R1, which is the ratio of the total amount of carbon and oxygen on one surface of the first principal surface 2 and second principal surface 3 to the ratio of the total amount of carbon and oxygen on the other surface, is, preferably, 0.3 or more and, for example, less than 1.0 (a requirement [2]). Hereinafter, the ratio R1 may be referred to as the first ratio R1. When the requirement [1] or requirement [2] is satisfied, the excessive decrease in the ratio of the total amount of carbon and oxygen on the first principal surface 2 or second principal surface 3 can be avoided. Thus, excellent adhesion can more surely be achieved on both of the first principal surface 2 and second principal surface 3.

Between the requirement [1] and requirement [2], more preferably, the requirement [2] is satisfied. When the requirement [2] is satisfied, excellent adhesion can more surely be achieved on both of the first principal surface 2 and second principal surface 3.

The first ratio R1 is, preferably, 0.4 or more, more preferably, 0.5 or more, even more preferably, 0.6 or more.

The whole region of each of the first principal surface 2 and second principal surface 3 or a part of the whole region satisfies the above-described ratio of the total amount. The part of the whole region accounts for, for example, 50% or more of the whole region, preferably 70% or more of the whole region, and 90% or more of the whole region.

### <Ratio of Total Amount of Carbon and Oxygen at Central Part in Thickness Direction>

The ratio of the total amount of carbon and oxygen at a central part 4 in the thickness direction of the magnetic sheet 1 is, for example, 10 mass % or more, preferably, 20 mass % or more and, for example, 60 mass % or less, preferably, 50 mass % or less. The central part 4 is a part between the first principal surface 2 and second principal surface 3. Specifically, the central part 4 is an internal part disposed at half the depth from the first principal surface 2 or second principal surface 3 in the thickness direction.

The above-described ratio of the total amount of carbon and oxygen on one surface of the first principal surface 2 and second principal surface 3 preferably equals the ratio of the total amount of carbon and oxygen at the central part 4 (a requirement [3]).

When the above-described ratio of the total amount of carbon and oxygen on one surface of the first principal surface 2 and second principal surface 3 is lower than the ratio of the total amount of carbon and oxygen at the central part 4, a ratio R2, which is the ratio of the total amount of carbon and oxygen on one surface of the first principal surface 2 and second principal surface 3 to the ratio of the total amount of carbon and oxygen at the central part 4, is, preferably, 0.3 or more and less than 1 (a requirement [4]). Hereinafter, the ratio R2 may be referred to as the second ratio R2.

When the requirement [3] and requirement [4] is satisfied, the excessive decrease in the ratio of the total amount of carbon and oxygen on the first principal surface 2 or second principal surface 3 can be avoided. Thus, the adhesion can be improved.

Between the requirement [3] and requirement [4], more preferably, the requirement [4] is satisfied. When the requirement [4] is satisfied, the adhesion on the first principal surface 2 or second principal surface 3 can be improved, and the cohesion of the magnetic sheet 1 can be improved.

The second ratio R2 is, preferably, 0.4 or more, more preferably, 0.5 or more, even more preferably, 0.6 or more. The second ratio R2 is, preferably, 0.9 or less, preferably, 0.8 or less.

The ratio of the total amount of carbon and oxygen at the central part 4 can be obtained by Energy-dispersive X-ray spectroscopy (EDX). Specifically, first, the magnetic sheet 1 is cut along the thickness direction to expose its cross-section. Thereafter, EDX analysis of the central part 4 in the cross-section is carried out.

Specifically, first, the magnetic sheet 1 is cut along the thickness direction to expose its cross-section. Thereafter, the EDX analysis of the central part 4 in the cross-section is carried out. The central part of the present application means the central part in the thickness direction when the magnetic sheet 1 is cut along the thickness direction and the cross-section of the magnetic sheet 1 is exposed. When the thickness direction is divided into three, the central part means a region of ⅓ of the central part in the thickness direction. When the thickness direction is divided into five, the central part means a region of 20% of the thickness. Although depending on the number of the divided parts of the thickness, the region of 10 to 30% in the thickness direction relative to the center may be observed as the central part

When the EDX analysis is carried out, it is necessary to designate a width direction in addition to its height as the measurement region. At the time, a rectangular region having a width five times to 10 times larger than its height is designated as the measurement region. For example, the measurement region may have a width about five times larger than its height.

When the EDX analysis of the central part 4 is carried out, the SEM observation of the cross-section is simultaneously carried out.

The thickness of the magnetic sheet 1 is not especially limited. The magnetic sheet I has a thickness of, for example, 1 μm or more and 1 mm or less.

Next, a method of producing the magnetic sheet 1 is described. The production method is not especially limited. The production method includes, for example, a first production method and a second production method.

### <First Production Method>

The first production method is described with reference to FIG. 2A and FIG. 2B.

In the first production method, first, a magnetic composition is prepared. The magnetic composition contains magnetic particles and resin. The magnetic composition is disclosed, for example, in Japanese Unexamined Patent Publication No. 2020-150057, Japanese Unexamined Patent Publication No. 2020-150060, Japanese Unexamined Patent Publication No. 2020-150063, and Japanese Unexamined Patent Publication No. 2020-150066. Examples of the magnetic particles include particles made of a soft magnetic material and preferably include magnetic particles made of flat Fe—Si alloys, flat Fe—Si—Al alloys, and spherical carbonyl iron powder. The ratio of the particles in the magnetic composition is, for example, 90 vol % or less, preferably, 80 vol % or less and, for example, 10 vol % or more, preferably, 20 vol % or more. Examples of the resin include thermoplastic resin, and thermosetting resin, and preferably include acryl resin and an epoxy resin composition. The ratio of the resin in the magnetic composition is, for example, 90 vol % or less, preferably, 80 vol % or less and, for example, 10 vol % or more, preferably, 20 vol % or more.

Preferably, an organic solvent is blended in the magnetic composition, thereby preparing varnish (a magnetic composition solution). Specifically, the varnish contains the magnetic particle, resin, and solvent. Examples of the solvent include an organic solvent and an aqueous solvent. Examples of the organic solvent include a ketone compound, an ester compound, an ether compound, and an amide compound. Examples of the ketone compound include acetone, and methyl ethyl ketone. Examples of the ester compound include ethyl acetate. Examples of the ether compound include propylene glycol monomethyl ether. Examples of the amide compound include N, N-dimethylformamide. Examples of the aqueous solvent include water and alcohol. Examples of the alcohol include methanol, ethanol, propanol, and isopropanol. For rapid solvent removal, preferably, an organic solvent is used as the solvent. The ratio of the solvent in the varnish is, for example, 5 mass % or more and, for example, 90 mass % or less. The solid content concentration in the varnish is, for example, 10 mass % or more and, for example, 95 mass % or less.

Next, the varnish is applied. As illustrated in FIG. 2A, for example, the varnish is applied to the release sheet 5. The release sheet 5 extends in a surface direction. The release sheet 5 has a third principal surface 6 and a fourth principal surface 7 facing each other in the thickness direction. At least, the third principal surface 6 is stripped. Examples of the release sheet 5 include a resin sheet and a metal sheet. Examples of the resin include polyester and polyolefin. Examples of the polyester include polyethylene terephthalate. Examples of the polyolefin include polyethylene and polypropylene, The release sheet 5 has a thickness of, for example, 1 μm or more and, for example, 500 μm or less.

The varnish is applied on the third principal surface 6 of the release sheet 5. To apply the varnish, for example, an applicator, a bar coater, or a brush is used. Preferably, an applicator is used. The application of the varnish is carried out mechanically or manually. Preferably, the application of the varnish is carried out manually.

In this manner, a coating film 8 is formed on the third principal surface 6. Just after the application, the coating film 8 still contains the solvent. When the resin contains thermosetting resin, the thermosetting resin is in A stage. The thickness of the coating film 8 is set so that the coating film 8 is the same as the magnetic sheet I in thickness after being dried.

Subsequently, the coating film 8 is left at normal temperature. Specifically, the normal temperature is 20° C. or more and 30° C. or less. The leaving time is, for example, 3 minutes or more, preferably, 5 minutes or more. The upper limit of the leaving time is not especially limited. Normal pressure is atmospheric pressure and approximately 0.1 MPa.

While the coating film 8 is left, winds blow around the coating film 8 and generation of a parallel stream and an impinging stream (both described below) is allowed. The upper limit of the wind speed of the parallel stream is, for example, 0.5 m/sec, preferably, 0.25 m/sec. The upper limit of the wind speed of the impinging stream is, for example, 1 m/sec, preferably, 0.5 m/sec. The wind speed is measured by a thermal anemometer Anemomaster.

Thereafter, the coating film 8 is dried by heating. As illustrated in FIG. 2B, for the heat dry, for example, a first dryer 9 is used. Examples of the first dryer 9 include a hot-air dryer 10, a hot plate, and an infrared lamp. As the first dryer 9, preferably, the hot-air dryer 10 is used. On the other hand, a handy dryer heats the coating film 8 by bringing the coating film 8 into contact with an impinging stream (described below). Thus, a handy dryer is not suitable as the first dryer 9.

As a preferred example of the first dryer 9, the hot-air dryer 10 on a desk is described. The hot-air dryer 10 includes a housing 11, a shelf board 12, a heat source (not illustrated), and an air blower (not illustrated). The housing 11 has a box shape. The shelf board 12 extends in a horizontal direction. The shelf board 12 is provided with a plurality of holes 13. The plurality of holes 13 penetrates the shelf board 12 in a vertical direction. Hot air can pass thought the plurality of holes 13. However, each of the holes 13 is smaller than the release sheet 5. The heat source (not illustrated) is disposed inside the housing 11. The air blower is in proximity to the heat source. The wind blowing from the air blower becomes warm air by contacting the heat source. The warm air flows along the shelf board 12 (the horizontal direction). Above the shelf board 12, the warm air reaches the downstream end in the flow direction, passes through the hole 13, and reaches under the shelf board 12. Under the shelf board 12, the warm air reaches the downstream end in the flow direction, passes through the hole 13, and reaches above the shelf board 12. In this manner, the warm air circulates in the housing 11 of the hot-air dryer 10.

The coating film 8 and release sheet 5 are inserted in the hot-air dryer 10. Specifically, the release sheet 5 is disposed on an upper surface of the shelf board 12.

In the hot-air dryer 10, an impinging stream that is the warm air impinging on the coating film 8 from above is suppressed as much as possible, However, in the hot-air dryer 10, a predetermined temperature is kept by a parallel stream parallel to the surface direction of the coating film 8, In this manner, the coating film 8 is heated. Specifically, the coating film 8 is moderately heated.

The parallel stream blows at a wind speed of, for example, 0.5 m/sec or more, preferably, 1 m/sec or more and, for example, 5 m/sec or less, preferably, 3.0 m/sec or less, more preferably, 2.5 m/sec or less. The wind speeds of the parallel stream and impinging stream are measured by a thermal anemometer Anemomaster.

The heating time is, for example, 1 minute or more, preferably, 2 minutes or more and, for example, 15 minutes or less, preferably, 10 minutes or less.

The internal temperature of the hot-air dryer 10 is, for example, 50° C. or more and, for example, 130° C. or less.

Drying the coating film 8 by the first dryer 9 removes the solvent from the coating film 8 and forms the magnetic sheet 1. When the resin contains thermosetting resin, the thermosetting resin is in B stage.

As illustrated in FIG. 2A, the first principal surface 2 of the magnetic sheet 1 produced by the first production method is an upper surface (front surface) and an opposite surface to the release sheet 5. The second principal surface 3 of the magnetic sheet 1 is a lower surface (rear surface) and a contact surface in contact with the release sheet 5.

The magnetic sheet 1 produced by the first production method satisfies, for example, the requirement [2] (see Example 1 in Table 2). In such a case, for example, the ratio of the total amount of carbon and oxygen on the first principal surface 2 is lower than the ratio of the total amount of carbon and oxygen on the second principal surface 3. Thus, the first ratio R1 is the ratio of the total amount of carbon and oxygen on the first principal surface 2 to the ratio of the total amount of carbon and oxygen on the second principal surface 3. In the first production method, the precipitation of the magnetic particles is suppressed. Thus, the ratio of the resin on the first principal surface 2 is appropriately lower than the ratio of the resin on the third principal surface 6. In other words, the resin is appropriately segregated on the second principal surface 3. Thus, both of the first principal surface 2 and second principal surface 3 can have excellent adhesiveness.

The magnetic sheet 1 produced by the first production method satisfies the requirement [4] (see Example 1 in Table 2). In such a case, for example, the ratio of the total amount of carbon and oxygen on the first principal surface 2 is lower than the ratio of the total amount of carbon and oxygen at the central part 4. The second ratio R2 of the ratio of the total amount of carbon and oxygen on the first principal surface 2 to the ratio of the total amount of carbon and oxygen at the central part 4 is 0.3 or more and less than 1. In the first production method, the precipitation of the magnetic particles is suppressed. Thus, the ratio of the resin on the first principal surface 2 is appropriately lower than the ratio of the resin at the central part 4. The decrease in the adhesion of the first principal surface 2 can be suppressed.

### <Second Production Method>

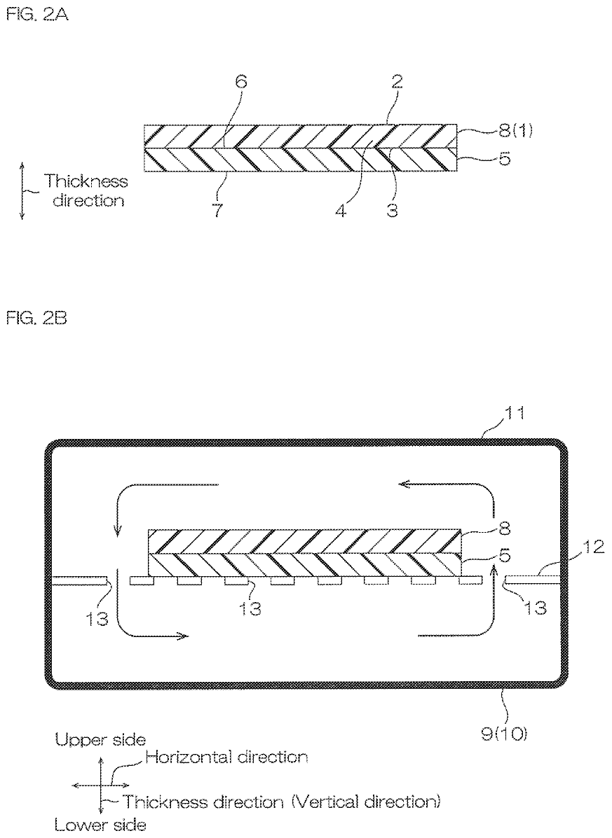

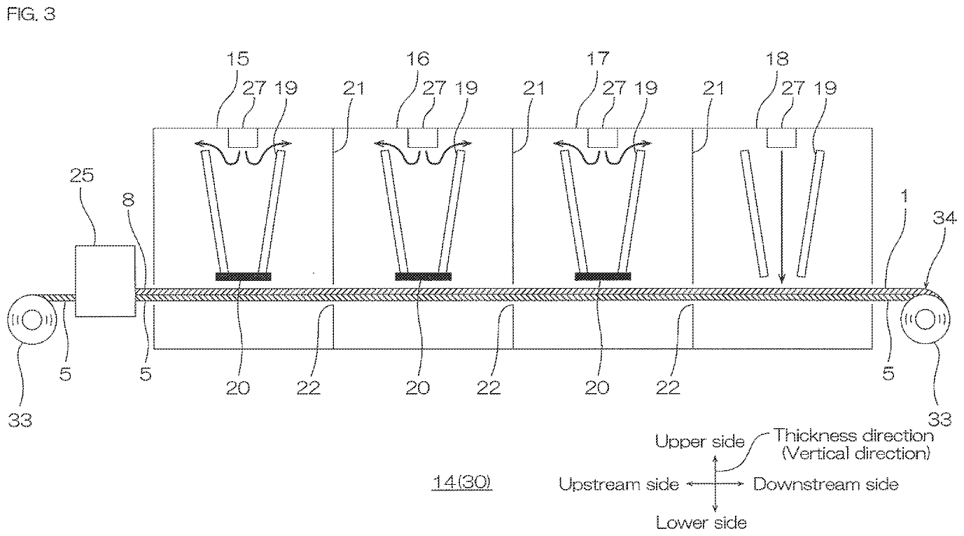

In the second production method, a magnetic composition (varnish) is prepared. The preparation method is the same as that in the first production method. Subsequently, the varnish is applied. The application method in the second production method is not especially limited. Examples of the application method include blade coating, gravure coating, fountain coating, cast coating, spin coating, comma coating, die coating, and roll coating. The application is carried out by, for example, a continuous coating method or a single-sheet coating method. The application is carried out mechanically or manually. For manufacturing efficiency, preferably, the application is carried out mechanically. To carry out the application mechanically, as illustrated in FIG. 3, a coater 25 is disposed to carry out the above-described application method. Specifically, the coater 25 is disposed between two rollers 33. The two rollers 33 are a feed roller and a roll-up roller, The feed roller feeds the release sheet 5. The roll-up roller rolls up a laminate sheet 34 including the release sheet 5 and magnetic sheet 1.

The release sheet 5 is fed from the feed roller and the varnish is continuously applied to the release sheet 5 using the coater 25. In the second production method, for example, a second dryer 30 is used to dry the coating film 8 by heating. As the second dryer 30, for example, a continuous dryer 14 is used.

The continuous dryer 14 is disposed at a downstream side in a conveyance direction, relative to the coater 25. The continuous dryer 14 includes a plurality of drying chambers 15, 16, 17, and 18.

The plurality of drying chambers 15, 16, 17, and 18 sequentially includes a first drying chamber a second drying chamber 16, a third drying chamber 17, and a fourth drying chamber 18 downstream in the conveyance direction in which the release sheet 5 is conveyed. The adjacent drying chambers are defined by separation walls 21. Openings 22 are formed at lower parts of the separation walls 21, respectively, and the release sheet 5 and coating film 8 pass through the openings 22. The first drying chamber 15, second drying chamber 16, third drying chamber 17 are configured to increase the internal temperature toward the downstream side in the conveyance direction. Each of the drying chambers 15, 16, 17, and 18 includes a heat source (not illustrated), an air blower 27, and a vent 19.

The vent 19 is disposed at the downstream side in a blow direction in which the air blower 27 blows, The vent 19 faces the coating film 8 being conveyed. The vent 19 has an opening with a cross-sectional area decreasing toward the coating film 8.

Each of the first drying chamber 15, second drying chamber 16, and third drying chamber 17 includes a shielding member 20. However, the fourth drying chamber 18 does not include a shielding member 20. Each of the shielding members 20 covers the exit of the vent 19. As the shielding member 20, for example, a pressure-sensitive adhesive tape (adhesive tape) is used. The shielding member 20 also works as a sealing tape. The shielding member 20 causes the warm air generated by the driving of the heat source (not illustrated) and air blower 27 to leak laterally from the entrance of the vent 19 without passing through the exit of the vent 19. The leakage does not substantially create an impinging stream of the warm air impinging on the coating film 8 from above, or slows down the impinging stream in each of the first drying chamber 15, second drying chamber 16, and third drying chamber 17. On the other hand, an impinging stream is generated in the fourth drying chamber 18.

Each of the first drying chamber 15, second drying chamber 16, and third drying chamber 17 is set at a predetermined internal temperature by the warm air leaking laterally from the above-described vent 19. The fourth drying chamber 18 is set at a. predetermined internal temperature by the above-described impinging stream. Each of the drying chambers 15, 16, 17, 18 has a temperature of, for example, 50° C. or more and, for example, 130° C. or less. Specifically, the first drying chamber 15 has a temperature of, for example, 50° C. or more and less than 70° C. The second drying chamber 16 has a temperature of for example, 70° C. or more and less than The third drying chamber 17 and fourth drying chamber 18 each have a temperature of, for example, 90° C. or more and, for example, 130° C. or less.

While the coating film 8 passes through the plurality of drying chambers 15, 16, 17, and 18 of the second dryer 30, the solvent is removed from the coating film 8 and the magnetic sheet 1 is formed on the upper surface of the release sheet 5. When the resin contains thermosetting resin, the thermosetting resin is in B stage. The magnetic sheet 1 forms the laminate sheet 34 together with the release sheet 5. The laminate sheet 34 is rolled up by the roll-up roller.

Also in the magnetic sheet 1 produced by the second production method, the first principal surface 2 is an upper surface (front surface) and an opposite surface to the release sheet 5. The second principal surface 3 of the magnetic sheet 1 is a lower surface (rear surface) and a contact surface in contact with the release sheet 5.

The magnetic sheet 1 produced by the second production method satisfies, for example, the requirement (see Example 2 in Table 2). In such a case, for example, the ratio of the total amount of carbon and oxygen on the first principal surface 2 equals the ratio of the total amount of carbon and oxygen on the second principal surface 3. Thus, the ratio of the resin on the first principal surface 2 equals the ratio of the resin on the third principal surface 6. As a result, the excellent adhesiveness of the first principal surface 2 and excellent adhesiveness of the second principal surface 3 can be balanced well.

The magnetic sheet 1 produced by the second production method satisfies, for example, the requirement [4] (see Example 2 in Table 2). In such a case, for example, the ratio of the total amount of carbon and oxygen on the second principal surface 3 is lower than the ratio of the total amount of carbon and oxygen al the central part 4. The second ratio R2 of the ratio of the total amount of carbon and oxygen on the second principal surface 3 to the ratio of the total amount of carbon and oxygen al the central part 4 is 0.3 or more and less than 1. In the second production method, the ratio of the resin on the second principal surface 3 is appropriately low in comparison with the ratio of the resin al the central part. Thus, the second principal surface 3 has excellent adhesion.

### <Variation of Second Production Method>

In the following variation, the same members and steps as in the above-described second embodiment are given the same numerical references and the detailed descriptions thereof are omitted. Further, the variation has the same operations and effects as those of the second embodiment unless especially described otherwise. Furthermore, the second embodiment and variation can appropriately be combined.

Although not illustrated, the second dryer 30 (continuous dryer 14) may not include the shielding member 20. In such a case, in each of the drying chambers 15, 16, 17, and 18, an impinging stream is generated. Thus, in comparison with the drying in the second production method, the coating film 8 is exposed to the impinging stream for a long time in the drying in the variation.

Thus, the front surface of the coating film 8 (corresponding to the first principal surface 2 of the magnetic sheet 1) is dried and solidified faster. Hence, the drying of the inside of the coating film 8 (corresponding to the central part 4 in the thickness direction of the magnetic sheet 1) is decelerated, and the magnetic particles go down. As a result, in the magnetic sheet 1, the ratio of the resin on the first principal surface 2 is appropriately higher than the ratio of the resin on the second principal surface 3.

In other words, the magnetic sheet 1 produced by the variation preferably satisfies the requirement [2] (see Example 3 in Table 2). In such a case, for example, the ratio of the total amount of carbon and oxygen on the second principal surface 3 is lower than the ratio of the total amount of carbon and oxygen on the first principal surface 2. Thus, the first ratio R1 is the ratio of the total amount of carbon and oxygen on the second principal surface 3 to the ratio of the total amount of carbon and oxygen on the first principal surface 2. In the second production method, the magnetic particles go down. However, the degree of the settling down is suppressed as much as possible. Hence, the ratio of the resin on the second principal surface 3 is appropriately low in comparison with the ratio of the resin on the first principal surface 2. In other words, the resin is appropriately segregated on the first principal surface 2. Thus, both of the second principal surface 3 and first principal surface 2 can have excellent adhesiveness.

The magnetic sheet 1 produced by the second production method satisfies also the requirement [3] (see Example 3 in Table 2). In such a case, for example, the ratio of the total amount of carbon and oxygen on the second principal surface 3 equals the ratio of the total amount of carbon and oxygen at the central part 4. Thus, the ratio of the resin on the second principal surface 3 equals the ratio of the resin at the central part 4. As a result, the second principal surface 3 has excellent adhesiveness. Further, the cohesion of the magnetic sheet 1 can be improved.

Among the above-described first production method, second production method, and variation of the second production method, to well balance the excellent adhesion of the first principal surface 2 and excellent adhesion of the second principal surface 3, the first production method and the second production method are preferred. To satisfy the requirements [2] and [4] and to keep a better balance of the adhesion, the first production method is more preferred. In addition to the above-described methods, to produce the magnetic sheet 1, a method that can produce at least a magnetic sheet 1 in which the ratio of the total amount of carbon and oxygen on the first principal surface 2 or second principal surface 3 is 10 mass % or more and 60 mass % or less is appropriately adopted.

### <Another Variation>

The number of the drying chambers in the second dryer 30 is not especially limited. The number of the drying chambers may be 1 to 3, or 5 or more. The shielding member 20 may be provided to all the vents 19.

### <Laminate Magnetic Sheet>

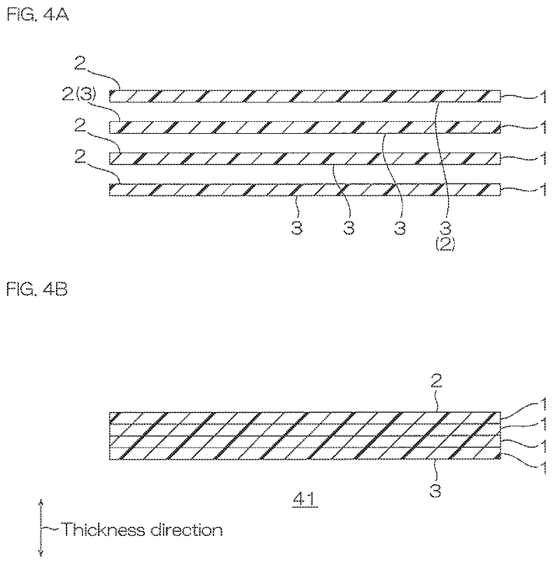

As illustrated in FIG. 4A, a plurality of magnetic sheets 1 is laminated to produce a laminate magnetic sheet 41. The laminate magnetic sheet 41 is also an exemplary magnetic sheet of the present invention. For example, the magnetic sheets 1 are adjacently disposed in the thickness direction, heated and pressed. The conditions for the heating and press are disclosed, for example, in Japanese Unexamined Patent Publication No. 2020-150057, Japanese Unexamined Patent Publication No. 2020-150060, Japanese Unexamined Patent Publication No. 2020-150063, and Japanese Unexamined Patent Publication No. 2020-150066. In the laminate of the plurality of magnetic sheets 1, as illustrated in FIG. 4A, the first principal surface 2 of one magnetic sheet 1 is brought into contact with the second principal surface 3 of the other magnetic sheet 1 adjacent to the above-described one magnetic sheet 1 in the thickness direction. Alternatively, as referred to the reference numerals in parentheses in FIG. 4A, the first principal surface 2 of one magnetic sheet 1 is brought into contact with the first principal surface 2 of the other magnetic sheet 1, Alternatively, the second principal surface 3 of one magnetic sheet 1 may be brought into contact with the second principal surface 3 of the other magnetic sheet 1.

As illustrated in FIG. 4B, the laminate magnetic sheet 41 has a first principal surface 2 and a second principal surface 3. The first principal surface 2 and second principal surface 3 of the laminate magnetic sheet 41 are the same as those of the magnetic sheet 1. In other words, the ratio of the total amount of carbon and oxygen on the first principal surface 2 or second principal surface 3 in the laminate magnetic sheet 41 is 10 mass % or more and 60 mass % or less.

Further, the laminate magnetic sheet 41 satisfies the requirement [1] or [2], and satisfies the requirement [3] or [4].

### <Inductor>

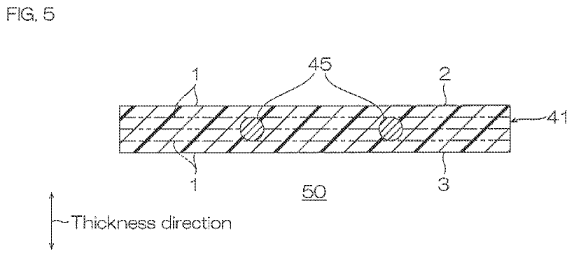

Next, an inductor 50 including the laminate magnetic sheet 41 is described with reference to FIG. 5. The inductor 50 has a sheet shape. The inductor 50 includes a plurality of wires 45 and a laminate magnetic sheet 41. The wires 45 are next to each other with a space in a width direction. The width direction is orthogonal to a direction in which the plurality of wires 45 extends and the thickness direction of the inductor 50. The wires 45 are parallel to each other. The wires 45 are disclosed in Japanese Unexamined Patent Publication No. 2020-150057, Japanese Unexamined Patent Publication No, 2020-150060, Japanese Unexamined Patent Publication No. 2020-150063. and Japanese Unexamined Patent Publication No. 2020-150066.

The laminate magnetic sheet 41 has the same shape as the inductor 50 does in the plan view. The laminate magnetic sheet 41 embeds the plurality of wires 45 in the cross section along the width direction and thickness direction. The laminate magnetic sheet 41 is formed of, for example, the plurality of magnetic sheets 1 illustrated in FIG. 4A.

### <Operations and Effects>

In the magnetic sheet 1 and laminate magnetic sheet 41, the ratio of the total amount of carbon and oxygen is 10 mass % or more and 60 mass % or less on the first principal surface 2 or second principal surface 3. Thus, the excessive decrease in the ratio of the resin can be suppressed on the first principal surface 2 and second principal surface 3.

Thus, the magnetic sheet 1, laminate magnetic sheet 41, and inductor 50 can achieve both of the excellent adhesiveness of the first principal surface 2 and the excellent adhesiveness of the second principal surface 3. In other words, the adhesion is balanced well between the first principal surface 2 and second principal surface 3. When the ratio of the total amount of carbon and oxygen on each of the first principal surface 2 and second principal surface 3 is 10 mass % or more and 50 mass % or less, the excessive segregation of the particles is suppressed on both of the first principal surface 2 and second principal surface 3, and the balance of the adhesion can be kept between both of the surfaces. When the magnetic sheet 1 and laminate magnetic sheet 41 satisfy the requirement [1] or [2], the excessive decrease in the ratio of the total amount of carbon and oxygen on one surface can be avoided. Thus, the excellent adhesion of the first principal surface 2 and the excellent adhesion of the second principal surface 3 can more surely be achieved. When the magnetic sheet 1 and laminate magnetic sheet 41 satisfy the requirement [3] or [4], the excessive decrease in the ratio of the total amount of carbon and oxygen on one surface can be avoided. Thus, the adhesion can be improved.

### EXAMPLE

Hereinafter, with reference to Examples and Comparison Examples, the present invention is more specifically described. The present invention is not limited to Examples and Comparison Examples in any way. The specific numeral values used in the description below, such as mixing ratios (contents), physical property values, and parameters can be replaced with the corresponding mixing ratios (contents), physical property values, parameters in the above-described “DESCRIPTION OF EMBODIMENTS”, including the upper limit values (numeral values defined with “or less”, and “less than”) or the lower limit values (numeral values defined with “or more”, and “more than”).

### Example 1

### <First Production Method>

55 parts by volume of magnetic particles made of flat-shaped Fe—Si alloys, 11.0 parts by volume of cresol novolac epoxy resin (main agent), 11.0 parts by volume of phenol resin (curing agent), parts by volume of an imidazole compound (curing accelerator), 21.2 parts by volume of thermoplastic resin (carboxyl group-containing acrylic acid ester copolymer), 0.4 parts by volume of a dispersing agent (phosphoric acid ester compound), 0.4 parts by volume of a thixotropic agent (urea-modified polyamide compound), and methyl ethyl ketone (organic solvent) were blended so that the volume ratio of the solid content became 11.5 vol %. The mixture was stirred, thereby preparing varnish.

The varnish was applied to a release sheet 5 using an applicator. In this manner, a coating film 8 was formed.

Thereafter, the coating film 8 was left at 2.5° C. in normal atmosphere for 3 minutes. The impinging stream blew at 0.12 [m/sec] and parallel stream blew at 0.33 [m/sec] to the coating film 8.

As illustrated in FIG. 2B, a hot-air dryer 10 was prepared as the first dryer 9. The heat source and air blower of the hot-air dryer 10 were activated to keep the internal temperature at 110° C. Next, the release sheet 5 and coating film 8 were inserted in the hot-air dryer 10 and left for 2 minutes. A parallel stream of the warm air blew at 2.9 [m/sec] in the hot-air dryer 10.

Thereafter, the release sheet 5 was taken out of the hot-air dryer 10. The methyl ethyl ketone was removed from the coating film 8. The thermosetting resin was in B stage. In this manner, a magnetic sheet 1 with a thickness of 85 μm was produced. The magnetic sheet 1 has a first principal surface 2 that is an opposite surface to the release sheet 5, and a second principal surface 3 in contact with the release sheet 5.

### Example 2

### <Second Production Method>

Varnish was prepared in the same manner as in Example 1.

As illustrated in FIG. 3, a continuous dryer 14 was prepared as the second dryer 30. The internal temperature of the first drying chamber 15 was 60° C. The internal temperature of the second drying chamber 16 was 80° C. The internal temperature of the third drying chamber 17 was 110° C. The internal temperature of the fourth drying chamber 18 was 110° C. The exit of a vent 19 in each of the first drying chamber 15 to the third drying chamber 17 was covered with a shielding member 20 made of a sealing tape. On the other hand, the exit of the vent 19 in the fourth drying chamber 18 was open.

The same release sheet 5 as in Example 1 bridged two rollers 33. The release sheet 5 was long enough to pass through a coater 25 and a continuous dryer 14.

The varnish was inserted in the coater 25 and applied to the release sheet, 5 by comma coating. In this manner, the coating film 8 was formed on the third principal surface 6 of the release sheet 5.

Subsequently, the coating film 8 was dried by the continuous dryer 14. Differently from Example 1, the coating film 8 was not left at 25° C. in Example 2. An impinging stream of warm air blew at 0.02 [m/sec] in each of the first drying chamber 15 to third drying chamber 17 of the continuous dryer 14, On the other hand, an impinging stream of warm air blew at 2.0 [m/sec] in the fourth drying chamber 18.

In this manner, a magnetic sheet 1 with a thickness of 85 μm was produced.

### Example 3

### <Variation of Second Production Method>

A magnetic sheet 1 with a thickness of 85 μm was produced in the same manner as in Example 2. However, a shielding member 20 was not provided in a hot-air dryer 10. An impinging stream of warm air blew at 2.0 [m/sec] in each of the first drying chamber 15 to the fourth drying chamber 18 of the continuous dryer 14.

### Comparison Example 1

A magnetic sheet 1 with a thickness of 85 μm was produced in the same manner as in Example 1. Instead of leaving the coating film 8 at 25° C., however, the coating film 8 was exposed to an impinging stream of warm air using a handy dryer. Thereafter, the coating film 8 was inserted in the first dryer 9. The handy dryer blew the impinging stream at 11.2 [m/sec] The follow items were measured to evaluate the magnetic sheet 1 of each Examples and Comparison Examples. The results are shown in Table 2.

### <Ratio of Total Amount of Carbon and Oxygen of Each of First Principal Surface 2, Second Principal Surface 3, and Central Part 4>

The magnetic sheet 1 was subjected to Energy-dispersive X-ray spectroscopy (EDX) to obtain the ratio of the total amount of carbon and oxygen of each of the first principal surface 2, second principal surface 3, and central part 4. The device and conditions for the measurement are as follows.

EIDX device: manufactured by HORIBA, Ltd., EMAX Evolution EX-470, X-MAX 150

Acceleration voltage applied to the first principal surface 2 and second principal surface 3: 10 kV

Acceleration voltage applied to the central part 4: 5 kV

The number of times of repetition: 3

When the above-described ratio of the total amount of carbon and oxygen was calculated in the EDX analysis, the elements derived from the pretreatment were removed.

At the same time as the EDX analysis, the SEM observation of the surface of the magnetic sheet 1 and the SEM observation of the cross section of the magnetic sheet 1 were carried out. The measurement device and conditions for the observations are as follows.

FE-SEM device: Hitachi, SUS020

Observed image: reflection electron image

### <SEM Observation of the Surface>

Acceleration voltage: 10 kV

Magnification: 200 times

Analysis field: Width of 600 μm×Height of 400 μm

### <SEM Observation of the Cross Section>

Acceleration voltage: 5 kV

Magnification: 2,000 times

Analysis field: Width of 50 μm Height of 10 μm

### <Adhesion>

### <Test A>

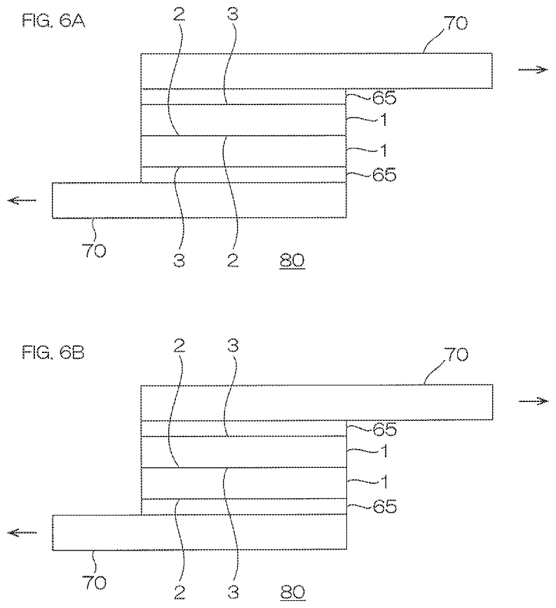

Two 5 mm×10 mm magnetic sheets 1 were prepared. As illustrated in FIG. 6A, one of the magnetic sheets 1 was disposed at an end of a 40 mm×10 mm copper plate 70 through an adhesive layer 65 with the same size as that of the magnetic sheet 1. The other magnetic sheet 1 was disposed at an end of a long copper plate 70 through an adhesive layer 65 with the same size as the magnetic sheet 1. Subsequently, the two magnetic sheets 1 were bonded to each other. At that time, the first principal surface 2 of one of the magnetic sheets 1 was brought into contact with the first principal surface 2 of the other magnetic sheet 1. Press was carried out twice for the bonding. To produce the adhesive layer 65, 61.5 parts by volume of magnetic particles made of spherical carbonyl iron powder, 9.6 parts by volume of cresol novolac epoxy resin (main agent), 9.6 parts by volume of phenol resin (curing agent), 0.3 parts by volume of an imidazole compound (curing accelerator), 18.5 parts by volume of thermoplastic resin (carboxyl group-containing acrylic acid ester copolymer), 0.5 parts by volume of an (ester phosphate-based) dispersing agent, and methyl ethyl ketone the organic solvent) were blended so that the solid content concentration became 30 vol %. The mixture was stirred, thereby preparing varnish. The varnish was applied and dried by the methods described in Example 1, thereby producing the adhesive layer 65.

### [First Press]

Press machine: Press with parallel plates
Temperature: 110° C.
Pressure: 0.9 MPa
Time: 1 minute

### [Second Press]

Press machine: Dry-laminator (manufactured by NIKKISO CO., LTD.)
Temperature: 170° C.
Pressure: 9 MPa

In this manner, a test sample 80 consisting of the copper plate 70, adhesive layer 65, two magnetic sheets 1, adhesive layer 65, and copper plate 70 sequentially disposed in the thickness direction was produced. One end in a longitudinal direction of one of the copper plates 70 protruded from the adhesive layers 65 and magnetic sheets 1. The other end of the longitudinal direction of the other copper plate 70 protruded from the adhesive layers 65 and magnetic sheets 1.

The one end in the longitudinal direction of the copper plate 70 and the other end of the longitudinal direction of the other copper plate 70 were pulled in the longitudinal direction to give a shearing force to the two magnetic sheets 1 (180-degree peel). The peel rate was 300 mm/min. The shearing force when the two magnetic sheets 1 were peeled was obtained as the adhesion of the magnetic sheets 1. The measurement was carried out 5 times and the average value was obtained.

### <Test B>

The adhesion of the two magnetic sheets 1 was measured in the same manner as in the test A. As illustrated in FIG. 6B, however, when the magnetic sheets 1 were bonded, the first principal surface 2 of one of the magnetic sheets 1 was brought into contact with the second principal surface 3 of the other magnetic sheet 1.

### <Evaluation of Adhesion>

The adhesions of the tests A and B were evaluated by the following criteria.
Excellent: 0.8≤[adhesion of test A]/[adhesion of test B]<1.2
Good: 0.7≤[adhesion of test A]/[adhesion of test B]<0.8, or 1.2≤[adhesion of test A]/[adhesion of test B]<1.5
Fair: 0.5≤[adhesion of test A]/[adhesion of test B]<0.7, or 1.5≤[adhesion of test A]/[adhesion of test B]<2
Bad: [adhesion of test A]/[adhesion of test B]<0.5, or [adhesion of test A]/[adhesion of test B]≥2

TABLE 1

| | | | | | | Comparative |
|---|---|---|---|---|---|---|
| | | Example 1 | Example 2 | | Example 3 | Example 1 |
| Production method | | First production | Second production | | Variation of | — |
| | | method | method | | Second production | |
| | | | | | method | |
| Conveyance | | Single-Sheet | Roll to Roll | | Roll to Roll | Single-Sheet |
| Application | Application | Applicator | Comma coating | | Comma coating | Applicator |
| | method | (manual coating) | (continuous coating) | | (continuous coating) | (manual coating) |
| Drying | Drying method | Left at 25° C. | Continuous dryer | | Continuous dryer | Handy dryer |
| | | Hot-air dryer | | | | Hot-air dryer |
| | Sealing tape in | — | Presence | — | Absence | — |
| | first to third drying | | | | | |
| | chambers | | | | | |
| Wind | Impinging stream | 0.12^{※1} | First drying | Fourth drying | First drying | 11.2^{※3} |
| speed | | | chamber to third | chamber | chamber to fourth | |
| [m/sec] | | | drying chamber | | drying chamber | |
| | | — | 0.02 | 2.0 | 2.0 | — |

| | | | | |
|---|---|---|---|---|
| Parallel stream | 0.33^{※1} | — | — | — |

| | |
|---|---|
| 2.9^{※2} | 2.9^{※2} |

^{※1}While leaving the coating film
^{※2}Hot-air dryer
^{※3}Handy dryer

TABLE 2

| | | | | | Comparative |
|---|---|---|---|---|---|
| | | Example 1 | Example 2 | Example 3 | Example 1 |
| Ratio of total amount | First principal surface | 17.5 | 17.5 | 50.8 | 88.0 |
| of carbon and oxygen | Second principal | 23.7 | 17.4 | 16.6 | 3.7 |
| [atomic %] | surface | | | | |
| | One of the surfaces | 17.5 | 17.4 | 16.6 | 3.7 |
| | The other surface | 23.7 | 17.5 | 50.8 | 88.0 |
| | Central part | 23.8 | 21.4 | 16.1 | 14.2 |
| First ratio R1 | One surface/the other | 0.7 | 1.0 | 0.3 | 0.04 |
| | surface | | | | |
| Satisfying requirement [1] or [2] | | [2] | [1] | [2] | — |
| Second ratio R2 | One surface/central | 0.7 | 0.8 | 1.0 | 0.3 |
| | part | | | | |
| Satisfying requirement [3] or [4] | | [4] | [4] | [3] | [4] |
| Adhesion | Test A [kN/cm²] | 0.75 | 0.73 | 0.62 | 0.68 |
| | Test B [kN/cm²] | 0.67 | 0.59 | 0.35 | 0.13 |
| | Test A/Test B | 1.1 | 1.2 | 1.8 | 5.2 |
| | Evaluation | Excellent | Good | Fair | Bad |

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The magnetic sheet is used for magnetic purposes.

### DESCRIPTION OF REFERENCE NUMERALS

1 magnetic sheet
2 first principal surface
3 second principal surface
41 laminate magnetic sheet
4 thickness direction central part
41 laminate magnetic sheet
45 wires
50 inductor

1. A magnetic sheet comprising:
a first principal surface; and
a second principal surface, the first principal surface and second principal surface facing each other in a thickness direction,
the magnetic sheet containing magnetic particles and resin,
wherein a ratio of a total amount of carbon and oxygen on the first principal surface or second principal surface is 10 mass % or more and 60 mass % or less.

2. The magnetic sheet according to claim 1, wherein the ratio of the total amount on each of the first principal surface and second principal surface is 10 mass % or more and 50 mass % or less.

3. The magnetic sheet according to claim 1, wherein the ratio of the total amount on the first principal surface equals the ratio of the total amount on the second principal surface, or
the ratio of the total amount on one surface of the first principal surface and second principal surface is lower than the ratio of the total amount on the other surface, and the ratio of the total amount on the one surface to the ratio of the total amount on the other surface is 0.3 or more and less than 1.0.

4. The magnetic sheet according to claim 1, wherein the ratio of the total amount on one surface of the first principal surface and second principal surface equals the ratio of the total amount at a central part in the thickness direction, or
the ratio of the total amount on the one surface is lower than the ratio of the total amount at the central part, and the ratio of the total amount on the one surface to the ratio of the total amount at the central part is 0.3 or more and less than 1.

5. An inductor comprising:
a wire; and
a magnetic sheet according to claim 1 and covering the wire.
